(19) United States
(12) Patent Application Publication
(10) Pub. No.: US 2024/0118402 A1
(43) Pub. Date: Apr. 11, 2024

(54) OBJECT DETECTION DEVICE AND METHOD

(71) Applicant: Murata Manufacturing Co., Ltd., Nagaokakyo-shi, Kyoto-fu (JP)

(72) Inventors: Yuuma WATABE, Nagaokakyo-shi (JP); Takaaki ASADA, Nagaokakyo-shi (JP); Shinichi SASAKI, Nagaokakyo-shi (JP)

(21) Appl. No.: 18/537,871

(22) Filed: Dec. 13, 2023

Related U.S. Application Data
(63) Continuation of application No. PCT/JP2022/025157, filed on Jun. 23, 2022.

(30) Foreign Application Priority Data
Oct. 7, 2021 (JP) 2021-165390

(51) Int. Cl. G01S 7/539; G01S 7/52; G01S 15/10

(52) U.S. Cl. CPC G01S 7/539; G01S 7/52004; G01S 15/10

(57) ABSTRACT

An object detection device includes a wave transmitter to transmit a sound wave to an object, a wave receiver to receive the sound wave and generate a signal representing a reception result, and a controller to control transmission of the sound wave by the wave transmitter and obtain the receive signal from the wave receiver. The controller is configured or programmed to output a transmit signal to cause the wave transmitter to transmit the sound wave and obtain a corresponding receive signal. The controller is configured or programmed to generate detection information about the object by performing complexification on a correlation signal representing a correlation between the transmit signal and the receive signal. A signal corrector is configured or programmed to correct any of the correlation signal, the receive signal, and the transmit signal to mitigate a direct-current component in the correlation signal targeted for the complex analysis.

### CROSS REFERENCE TO RELATED APPLICATIONS

This application claims the benefit of priority to Japanese Patent Application No. 2021-165390 filed on Oct. 7, 2021 and is a Continuation Application of PCT Application No. PCT/JP2022/025157 filed on Jun. 23, 2022. The entire contents of each application are hereby incorporated herein by reference.

### BACKGROUND OF THE INVENTION

### 1. Field of the Invention

The present invention relates to object detection devices and methods for detecting information such as a distance to an object by transmitting and receiving, for example, ultrasonic waves.

### 2. Description of the Related Art

As an ultrasonic distance measuring method, a publication authored by Kato, S., Kurosawa, M., & Hirata, S., “Multi Channel of Ultrasonic Distance Measurement Using Linear Period Modulation Signals of Different Modulation Rate”, Proceedings of the Acoustical Society of Japan, March 2011, pp. 1563-1564, hereinafter referred to as “Kato”, discloses a method for measuring a distance by transmitting an ultrasonic pulse toward a measurement target and measuring a time delay until reception of an echo reflected by the measurement target. This method measures the time delay based on a peak in a function that represents a relationship between the transmit signal and the echo. At this time, if a cross-correlation function regarding the transmit signal and the echo is used, the time of the peak can change, for example, due to the influence of the Doppler effect caused by movements of the measurement target. Considering this, the method in Kato obtains the envelope based on the sum of the squares of the cross-correlation function and its quadrature components and measures the time delay using the time of the peak of the envelope.

### SUMMARY OF THE INVENTION

Example embodiments of the present invention provide object detection devices and methods capable of accurately generating detection information about an object as a result of transmitting and receiving sound waves.

An object detection device according to an example embodiment of the present invention includes a wave transmitter to transmit a sound wave to an object, a wave receiver to receive a sound wave and generate a receive signal that represents a reception result, and a controller configured or programmed to control transmission of a sound wave by the wave transmitter and obtain the receive signal from the wave receiver. The controller is configured or programmed to output a transmit signal to cause the wave transmitter to transmit a sound wave and obtain a corresponding receive signal, and generate detection information about the object by complex analysis to perform complexification on a correlation signal that represents a correlation between the transmit signal and the receive signal, and a signal corrector configured or programmed to correct any of the correlation signal, the receive signal, and the transmit signal to mitigate a direct-current component in the correlation signal that is targeted for the complex analysis.

Example embodiments of the present invention also provide methods, non-transitory computer-readable media including computer programs, and combinations thereof.

The object detection devices and methods according to example embodiments of the present invention are each able to accurately generate detection information about an object as a result of transmitting and receiving sound waves.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 illustrates a displacement detection device according to a first example embodiment of the present invention.

FIG. 2 is a block diagram illustrating a configuration of the displacement detection device according to the first example embodiment of the present invention.

FIGS. 3A and 3B illustrate an example architecture of a wave transmitter in the displacement detection device.

FIG. 4 is a block diagram illustrating functional elements of a controller of the displacement detection device of the first example embodiment of the present invention.

FIGS. 5A and 5B provide graphs illustrating a transmit signal in the displacement detection device.

FIG. 6 is a graph illustrating an analytic signal in the displacement detection device.

FIGS. 7A and 7B provide graphs illustrating an envelope and a phase curve of an analytic signal as an example.

FIGS. 8A and 8B provide graphs illustrating envelopes and phase curves of the analytic signal based on ideal receive signals.

FIGS. 9A and 9B provide graphs illustrating transmit signals without DC components.

FIGS. 10A and 10B illustrate a problem relating to DC components in the displacement detection device.

FIG. 11 is a flowchart illustrating an overall operational process of the displacement detection device according to the first example embodiment of the present invention as an example.

FIGS. 12A and 12B illustrate the overall operational process of the displacement detection device according to the first example embodiment of the present invention.

FIG. 13 is a flowchart illustrating an analytic signal generation operation of the displacement detection device of the first example embodiment of the present invention as an example.

FIGS. 14A and 14B illustrate effects of the displacement detection device.

FIG. 15 is a block diagram illustrating functional elements of a controller of a displacement detection device according to a second example embodiment of the present invention.

FIG. 16 is a flowchart illustrating an overall operational process of the displacement detection device according to the second example embodiment of the present invention as an example.

FIG. 17 is a block diagram illustrating functional elements of a controller of a displacement detection device according to a modification of the second example embodiment of the present invention.

FIG. 18 is a block diagram illustrating functional elements of a controller of a displacement detection device according to a third example embodiment of the present invention.

FIG. 19 illustrates an operation of the displacement detection device according to the third example embodiment of the present invention.

FIG. 20 is a block diagram illustrating a configuration of a displacement detection device according to a modification of the third example embodiment of the present invention.

### DETAILED DESCRIPTION OF THE EXAMPLE EMBODIMENTS

Hereinafter, object detection devices according to example embodiments of the present invention will be described with reference to the accompanying drawings.

The example embodiments will be presented as illustrative examples. As one would anticipate, the configurational features described in the various example embodiments may be partially replaced or combined. In second and subsequent example embodiments, descriptions of features common to the first example embodiment will not be repeated, instead, only the distinct features will be explained. In particular, the same effects and advantages achieved by the same configurational features will not be mentioned in every example embodiment.

### First Example Embodiment

In a first example embodiment, an example of an object detection device applicable for detecting small displacements of an object will be described. The following describes a displacement detection device as an example of an object detection device according to the present example embodiment.

### 1. Configuration

### 1-1. Outline

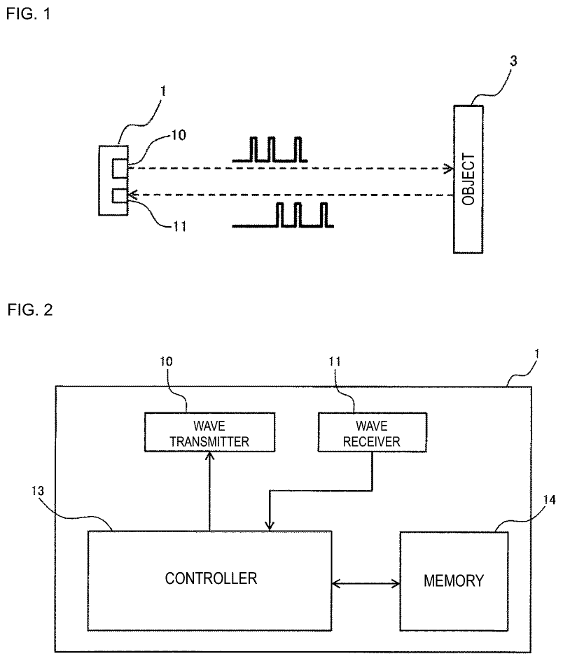

A displacement detection device according to the first example embodiment will be outlined with reference to FIG. 1.

FIG. 1 outlines a displacement detection device 1 of the present example embodiment. The displacement detection device 1 of the present example embodiment is implemented using a thermophone, which is a device designed to generate sound waves through thermal excitation. The displacement detection device 1 is operable to detect information of, for example, the distance to an object 3 by transmitting and receiving a sound wave and generate detection information about the object 3.

The displacement detection device 1 is applicable, for example, for medical use to measure patients' heartbeats or respiration. Examples of the object 3 targeted for detection in this case include patients' body surfaces. The displacement detection device 1 is not limited to medical use and is applicable for various purposes. For example, for in-vehicle use, the driver or occupant may be targeted for detection by the displacement detection device 1. The object 3 targeted for detection is not limited to a living body such as a human and may be, for example, an article. The displacement detection device 1 may be applicable, for example, for industrial use to inspect containers. More specifically, the displacement detection device 1 may be used to measure small variations in the distance to the location at which a label is attached on the container surface.

To detect information of, for example, small distances as described above, the displacement detection device 1 transmits a chirp wave, in which the frequency changes over time, toward the object 3 and receives a reflected wave of the chirp wave reflected by the object 3, in other words, an echo. Because the displacement detection device 1 is implemented using a thermophone, the displacement detection device 1 is able to generate sound waves that have wide-range frequency characteristics, such as chirp waves.

The displacement detection device 1 of the present example embodiment detects changes in the distance to the object 3, in other words, displacements of the object 3, by repeatedly transmitting and receiving sound waves as described above. Displacements of the object 3 represent an example of the detection information in the present example embodiment. A configuration of the displacement detection device 1 will be detailed below.

### 1-2. Device Configuration

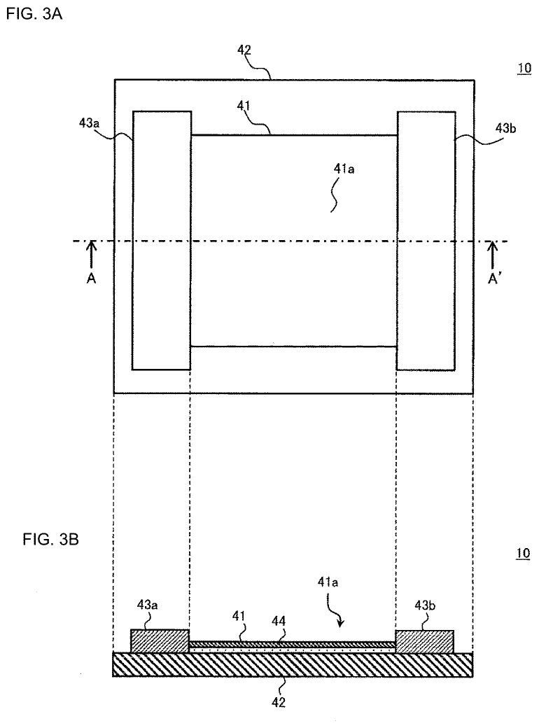

A configuration of the displacement detection device 1 of the present example embodiment will be described with reference to FIGS. 1 to 3B. FIG. 2 is a block diagram illustrating a configuration of the displacement detection device 1. FIGS. 3A and 3B illustrate an example architecture of a wave transmitter in the displacement detection device 1 of the present example embodiment.

The displacement detection device 1 of the present example embodiment includes, for example, as described in FIG. 2, a wave transmitter 10, a wave receiver 11, a controller 13, and a memory 14. For example, as illustrated in FIG. 1, the wave transmitter 10 and the wave receiver 11 are disposed close to each other at a side facing the object 3 of the displacement detection device 1. The wave transmitter 10 and the wave receiver 11 are communicatively coupled to the controller 13, for example, via various signal lines.

The wave transmitter 10 of the present example embodiment includes a thermophone as a sound source. The wave transmitter 10 is able to generate an ultrasonic wave of, for example, a frequency of 20 kHz or higher. The wave transmitter 10 is able to generate a chirp wave in which the frequency is modulated across a width range of, for example, about 20 kHz to about 100 kHz by using the thermophone. The wave transmitter 10 of the present example embodiment is able to generate a chirp wave that is, for example, a linear frequency chirp, in which the frequency linearly changes over time. The use of the thermophone makes the wave transmitter 10 small and light in weight.

The wave transmitter 10 may include, for example, a drive circuit to drive the thermophone. The wave transmitter 10 is operable to generate a sound wave by driving the thermophone with the drive circuit, for example, based on a transmit signal inputted from the controller 13. The wave transmitter 10 may include as the drive circuit, for example, a switching circuit that is implemented by a metal-oxide-semiconductor field-effect transistor (MOSFET). The drive circuit of the wave transmitter 10 may determine, for example, the frequency range of the sound wave to be generated, the chirp length that represents the cycle for changing the frequency, intensity, the signal length, and directivity. The wave transmitter 10 is not necessarily configured to generate ultrasonic waves. The wave transmitter 10 may generate sound waves in various frequency ranges. The wave transmitter 10 may be implemented using any non-directional sound source that does not have a particular directivity or any sound source that has a variable or fixed directivity.

FIG. 3A is a plan view of the wave transmitter 10 of this example architecture. FIG. 3B is a sectional view of the wave transmitter 10 along line A-A′ in FIG. 3A. The wave transmitter 10 includes, as structural elements of the thermophone to generate sound waves by heating air, for example, a heating element 41, a substrate 42, a pair of electrodes 43a and 43b, and a thermal insulating layer 44.

The heating element 41 and the thermal insulating layer 44 are stacked on the substrate 42. The heating element 41 is embodied as a resistive body. The heating element 41 generates heat in response to receiving current from the drive circuit through the electrodes 43. The heating element 41 is disposed such that a sound emitting surface 41a of the heating element 41 is in contact with air. Changes in temperature of the heating element 41 causes the air surrounding the sound emitting surface 41a to expand or contract. As a result, air pressure, in other words, sound waves are generated near the sound emitting surface 41a. The thermal insulating layer 44 is provided between the heating element 41 and the substrate 42. The thermal insulating layer 44 inhibits thermal conduction from the heating element 41 to the portion opposite the sound emitting surface 41a. The substrate 42 dissipates heat conducted from the heating element 41.

Referring back to FIG. 2, the wave receiver 11 is implemented by a microphone such as a micro electro mechanical system (MEMS) microphone. The wave receiver 11 receives an echo from the object 3 and generates a receive signal indicating the reception result. The length between the wave receiver 11 and the wave transmitter 10 is preset based on consideration factors such as the distance from the displacement detection device 1 to the object 3 in expected detection operations. The wave receiver 11 is not necessarily a MEMS microphone. Instead, the wave receiver 11 may be implemented by, for example, any microphone with the frequency characteristic that allows reception of width-range ultrasonic waves transmitted by the wave transmitter 10. For example, a condenser microphone may be used as the wave receiver 11. The wave receiver 11 may be non-directional or have various kinds of directivity.

The controller 13 is configured or programmed, or otherwise operable, to control the overall operational process of the displacement detection device 1. The controller 13 may be implemented by, for example, a microcomputer. The controller 13 is configured or programmed to perform particular functions in cooperation with software. The controller 13 is configured or programmed to perform various functions by reading the data and program stored in the memory 14 and performing various kinds of computational operations. The controller 13 is configured or programmed to perform to, for example, generate a transmit signal designed to cause the wave transmitter 10 to generate a chirp wave and output the transmit signal to the wave transmitter 10. The controller 13 is configured or programmed to, for example, store the generated transmit signal in the memory 14. In the displacement detection device 1 of the present example embodiment, the controller 13 is configured or programmed to include, for example, as a functional element, a direct-current (DC) offsetting unit 15 (described later) to perform offset correction on signals. The DC offsetting unit 15 will be described later. The DC offsetting unit is an example of a signal correcting unit or signal corrector in the present example embodiment. The controller 13 will be detailed later.

The controller 13 may be a hardware circuit such as a dedicated electronic circuit designed to implement particular functions or a reconfigurable electronic circuit. The controller 13 may be implemented by various semiconductor integrated circuits such as a central processing unit (CPU), a microprocessor unit (MPU), a digital signal processor (DSP), a field-programmable gate array (FPGA), and an application-specific integrated circuit (ASIC). The controller 13 may include an analog/digital (A/D) converter and a digital/analog (D/A) converter to perform A/D conversion or D/A conversion on various signals.

The memory 14 is a storage medium to store the program and data needed to implement the functions of the controller 13. The memory 14 may be implemented by, for example, a flash memory. For example, the memory 14 is operable to store the transmit signal generated by the controller 13.

### 1-3. Controller

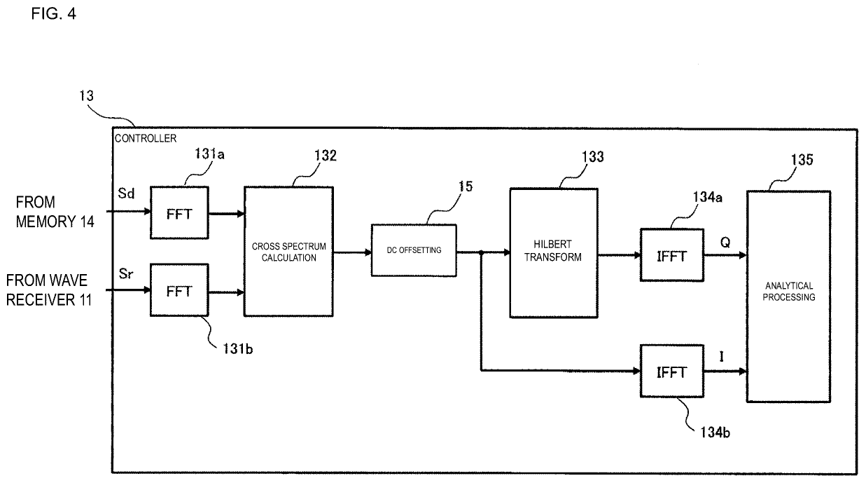

The controller 13 in the displacement detection device 1 of the present example embodiment will be detailed with reference to FIG. 4.

FIG. 4 is a block diagram illustrating functional elements of the controller 13. The controller 13 is configured or programmed to include, for example, as functional units, as well as the DC offsetting unit 15, FFT units 131a and 131b, a cross spectrum calculation unit 132, a Hilbert transform unit 133, IFFT units 134a and 134b, and an analytical processing unit 135, as illustrated in FIG. 4. The DC offsetting unit 15 implements a function of offset correction by a computational operation of removing DC components included in signals. DC components will be described later. The functional units 131 to 135 respectively implement a function of fast Fourier transform (FFT), a function of cross spectrum calculation, a function of Hilbert transform, a function of inverse fast Fourier transform (IFFT), and a function of analytical processing that will be described later.

The controller 13 is operable to receive, for example, a transmit signal Sd from the memory 14 and a receive signal Sr from the wave receiver 11 and perform signal processing with the functional units 131 to 135. The functional units 131 to 135 are able to cyclically operate, for example, at a predetermined measurement frame rate (by way of example, 30 frames/second). The measurement frame rate will be described later.

A series of operations by the FFT units 131 to the IFFT units 134 among the functional units 131 to 135 is performed to generate analytic signals based on the transmit signal Sd and the receive signal Sr for the individual frames. The analytic signal is a complex signal defined by a cross-correlation function between the transmit signal Sd and the receive signal Sr. The analytic signal is used for displacement detection by the displacement detection device 1. The cross-correlation function represents the correlation between the two signals Sd and Sr in the time domain.

The FFT unit 131a is operable to calculate the fast Fourier transform on the transmit signal Sd inputted to the controller 13 and output the transformation result of transformation from the time domain into the frequency domain to the cross spectrum calculation unit 132. The FFT unit 131b is operable to, similarly to calculating the fast Fourier transform on the transmit signal Sd, calculate the fast Fourier transform on the receive signal Sr inputted to the controller 13 and output the transformation result to the cross spectrum calculation unit 132.

The cross spectrum calculation unit 132 is operable to calculate the cross spectrum based on the Fourier transform results of the signals Sd and Sr calculated by the FFT units 131. In the present example embodiment, the cross spectrum calculation unit 132 is operable to output the calculated cross spectrum to the DC offsetting unit 15. The cross spectrum corresponds to the Fourier transform of the cross-correlation function between the transmit signal Sd and the receive signal Sr. The cross spectrum determines the multiple frequency components of the cross-correlation function. The cross-correlation function is obtained by calculating the inverse Fourier transform of the cross spectrum.

In the displacement detection device 1 of the present example embodiment, the DC offsetting unit 15 is operable to perform offset correction on the cross spectrum and output the calculation result to the Hilbert transform unit 133 and the IFFT unit 134b.

The Hilbert transform unit 133 is operable to calculate the Hilbert transform of the inputted cross spectrum and output the transformation result of shifting the individual frequency components of the cross spectrum by π/2 to the IFFT unit 134a.

The IFFT unit 134a is operable to calculate the inverse fast Fourier transform of the cross spectrum that has been subjected to the Hilbert transform and output the transformation result of transformation from the frequency domain into the time domain to the analytical processing unit 135. The IFFT unit 134b is operable to calculate the inverse fast Fourier transform of the cross spectrum before the Hilbert transform and output the transformation result to the analytical processing unit 135.

As a result of the computational operation described above, a signal I representing the cross-correlation function between the transmit signal Sd and the receive signal Sr is outputted as the transformation result obtained by the IFFT unit 134b. A signal Q orthogonal to the signal I is outputted as the transformation result obtained by the IFFT unit 134a.

The analytical processing unit 135 is operable to generate an analytic signal in which the signals I and Q respectively serve as the real part and the imaginary part and process the analytic signal. The generated analytic signal based on the transmit signal Sd and the receive signal Sd represents an analytic function in the complex domain. In the following, the signals I and Q are respectively referred to as an in-phase component I and a quadrature component Q of an analytic signal.

The various functions described above of the controller 13 may be, for example, implemented by a program stored in the memory 14 or partially or entirely implemented by a hardware circuit.

### 1-4. Transmit Signal

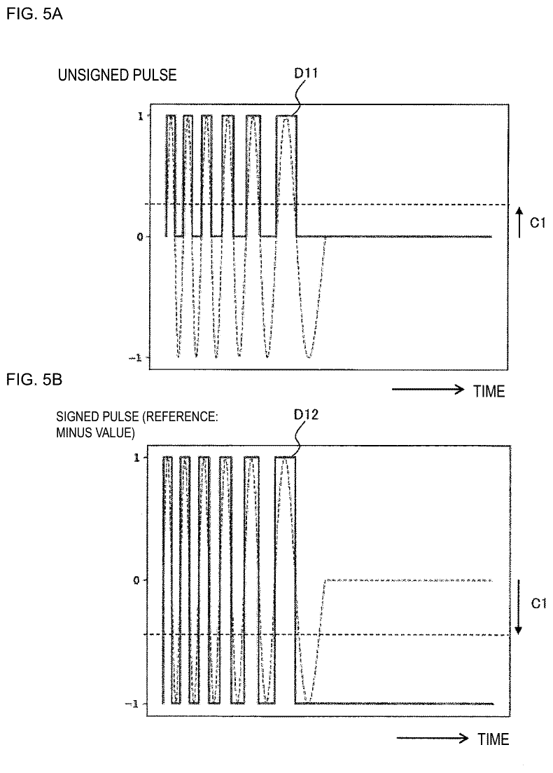

The transmit signal Sd in the displacement detection device 1 of the present example embodiment will be described with reference to FIGS. 5A and 5B.

FIGS. 5A and 5B provide graphs illustrating the transmit signal Sd in the displacement detection device 1 of the present example embodiment. FIG. 5A presents, as an example, signal data D11, which can be represented as the transmit signal Sd that the drive circuit uses to drive the thermophone in the wave transmitter 10 of the displacement detection device 1. The signal data D11 is previously store in the memory 14, for example, for the controller 13 to output the transmit signal Sd to the wave transmitter 10.

As the transmit signal Sd, the displacement detection device 1 uses a switching signal including pulses. In the example in FIG. 5A, a pulse-width modulated chirp signal in which the series of pulses varies over time with respect to time width is output as the transmit signal Sd. As illustrated in FIG. 5A, the signal data D11 is represented as a signal including unsigned pulses. The unsigned pulses have amplitudes that vary in the positive range starting from a value of zero, using a voltage of “0” as a reference. FIGS. 5A and 5B illustrate the waveforms of signals as sine chirps by dotted lines for description.

The wave transmitter 10 of the displacement detection device 1 is operable to turn on or off the drive circuit based on the transmit signal Sd. Accordingly, in the thermophone of the wave transmitter 10, the heating element 41 illustrated as an example in FIGS. 3A and 3B repeatedly generates heat and stops heat generation, and as a result, a sound wave including a series of pulses is generated. The aforementioned reference of the transmit signal Sd corresponds to, for example, when the thermophone is in the off-state, in other words, when heat generation is stopped. The transmit signal Sd in the displacement detection device 1 of the present example embodiment includes, as illustrated in FIG. 5A, a direct-current (DC) component C1 unlike a sine chirp signal. The DC component C1 has an average amplitude that deviates from a value of zero. For example, the transmit signal Sd, which represents the signal data D11, has amplitudes that change within the positive side with respect to a value of zero as a reference. This means that the transmit signal Sd includes the DC component C1 as a positive component.

To generate the transmit signal Sd, the displacement detection device 1 of the present example embodiment does not necessarily use the signal data D11 in FIG. 5A. The displacement detection device 1 may use a different kind of signal data. FIG. 5B presents signal data D12 as an example of a different kind of signal data that can be used for the transmit signal Sd. The signal data D12 is represented as a signal including signed pulses with a minus (−) reference. The signed pulses have amplitudes that vary in the range of negative to positive values, with a negative voltage serving as a reference. The transmit signal Sd representing the signal data D12 includes the DC component C1 as a negative component.

The transmit signal Sd is not necessarily a pulse-width modulated chirp signal. The transmit signal Sd may be, for example, a pulse-interval modulated chirp signal. In pulse interval modulation, the intervals between adjacent pulses among a series of pulses, in other words, the durations for which the pulses remain in the off-state vary over time. This configuration shortens the durations in the on-state, reducing electric power consumption in the wave transmitter 10. In the examples in FIGS. 5A and 5B, the transmit signal Sd is a down-chirp signal, in which the frequency decreases over time. However, the transmit signal Sd may be an up-chirp signal, in which the frequency increases over time.

The transmit signal Sd is not necessarily a linear frequency chirp. The transmit signal Sd may be, for example, a linear period chirp signal, in which the period linearly changes with time. The transmit signal Sd may be, for example, a signal designed to generate width-range modulated waves, implemented using a spread code such as an M-sequence code or a Gold code.

### 2. Operation

The following describes an operation of the displacement detection device 1 configured as described above.

2-1. Method for Detecting small Displacements

As an operational example of the displacement detection device 1 of the present example embodiment, a method for detecting changes in the distance to the object 3, in other words, displacements of the object 3 will be described with reference to FIGS. 1, 6, 7A, and 7B.

The displacement detection device 1 of the present example embodiment performs a measurement operation in each frame, repeating this measurement operation for subsequent frames. For example, in the measurement operation for one frame, as illustrated in FIG. 1, the wave transmitter 10 transmits a chirp wave to the object 3 once, and the wave receiver 11 receives an echo of the chirp wave. In the displacement detection device 1, the controller 13 generates an analytic signal so as to analyze the relationship between a transmit signal and a receive signal for each measurement frame.

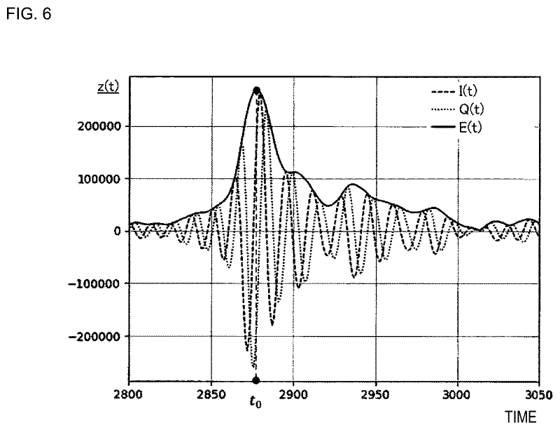

FIG. 6 is a graph illustrating an analytic signal z(t) in the displacement detection device 1. FIG. 6 illustrates an analytic signal z(t) for one frame as an example. The analytic signal z(t) ranges over complex numbers. Each complex number is obtained through complexification and include an in-phase component I(t), which represents the cross-correlation function between the transmit signal and the receive signal, as the real part and a corresponding quadrature component Q(t) as the imaginary part.

The displacement detection device 1 calculates, for example, an envelope E(t)=|z(t)| of the analytic signal z(t) to detect a peak time t₀. An amplitude |z(t)| at the peak time t₀ is the highest amplitude of the analytic signal z(t) in a single frame. Accordingly, it is assumed that the peak time t₀ corresponds to the timing when the object 3 reflects a chirp wave during the transmission and reception of the chirp wave within the frame.

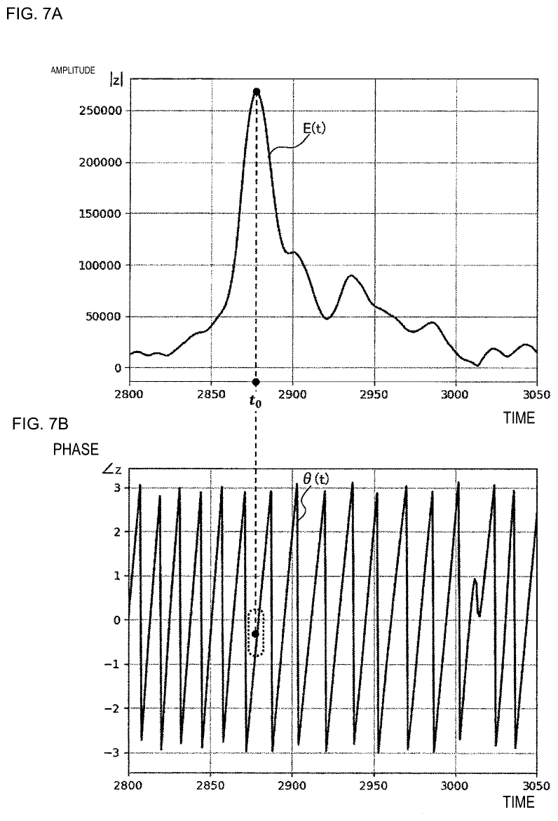

In addition to the envelope E(t), the displacement detection device 1 of the present example embodiment analyzes the analytic signal z(t) obtained through complexification of the cross-correlation function with regard to a phase ∠z(t). FIG. 7A illustrates the envelope E(t) of the analytic signal z(t) in FIG. 6 as an example. FIG. 7B illustrates a phase curve θ(t) of the analytic signal z(t) in FIG. 6 as an example.

The phase curve θ(t) represents the correspondences between the phase ∠z(t), which is defined within the range of the complex numbers of the analytic signal z(t), and a time t. The phase curve θ(t) illustrated as an example in FIG. 7B has steep gradients in a saw-shaped graph plot that correlates with the oscillations in the envelope E(t) in FIG. 7A. Each gradient of the phase curve θ(t) is determined by the frequency at each time t in the analytic signal z(t) (in other words, instantaneous frequency).

It is assumed that in the phase curve θ(t) of the analytic signal z(t) for each frame, a phase ∠z(t₀) at the peak time t₀ in the frame, which theoretically corresponds to a value of zero, can include offset values attributable to various noises in practical applications. Additionally, it is theoretically assumed that the phase curve θ(t) exhibits higher linearity near the peak time t₀ of the envelope E(t).

The displacement detection device 1 of the present example embodiment measures the amount of displacement of the object 3 by, for example, calculating the phase difference between two successive frames using the peak time t₀ in one of the two frames as a reference and converting the phase difference. This conversion from the phase difference enables highly accurate calculation of small displacement amounts, for example, by using the steepness of the gradients in the phase curve e(t).

### 2-2. Problem of DC Component

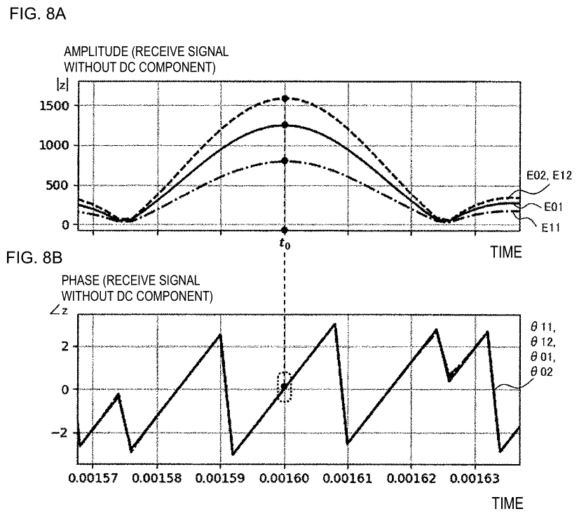

The displacement detection device 1 of the present example embodiment implements highly accurate object detection of, for example, detecting small displacements by complex analysis using the analytic signal z(t) obtained through complexification of the cross-correlation function as described above. Through diligent research, the inventors of the present application have identified a problem: in the aforementioned complex analysis, DC components of the transmit signal Sd and the receive signal Sr can impede highly accurate detection. This problem relating to DC components of the transmit and receive signals will be described with reference to FIGS. 8A to 10B.

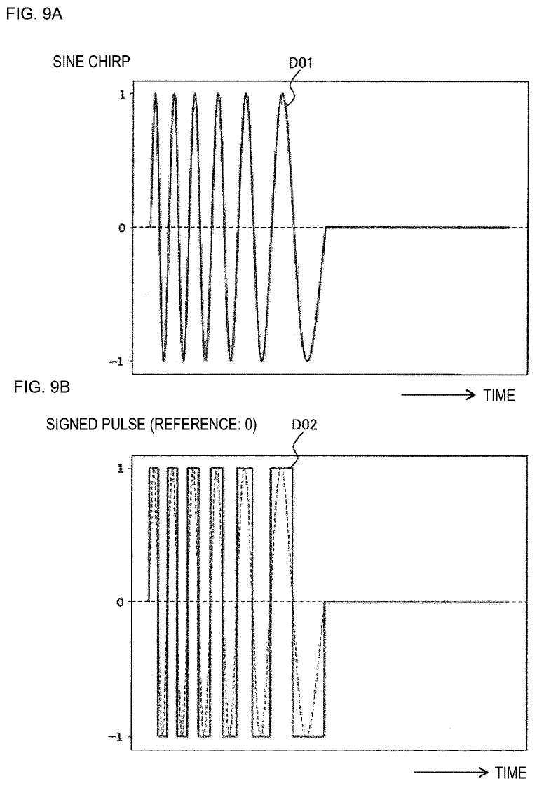

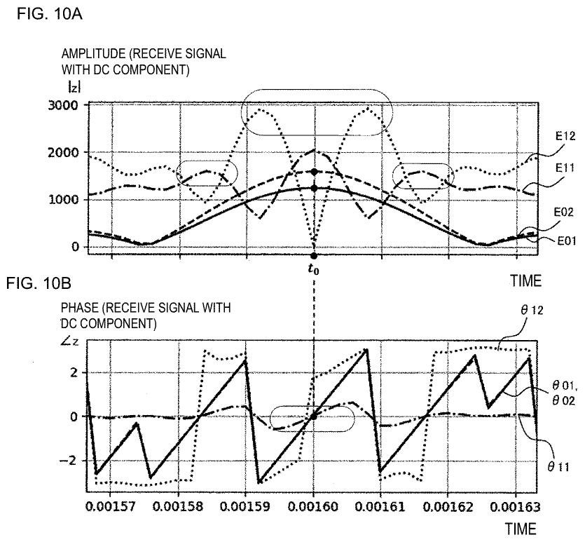

FIGS. 8A and 8B provide graphs illustrating envelopes and phase curves of the analytic signal z (t) based on ideal receive signals. FIGS. 9A and 9B provide graphs illustrating transmit signals without DC components. FIGS. 10A and 10B illustrate the problem relating to DC components in the displacement detection device 1.

FIG. 8A illustrates envelopes of the analytic signals z(t) based on the signals in FIGS. 5, 9A, and 9B and the receive signal Sr when the receive signal Sr includes no DC component. The analytic signals z(t) are generated by performing complexification on the cross-correlation functions between the transmit signals Sd generated using signal data D01 to D12 in FIGS. 5A, 5B, 9A, and 9B and the receive signal Sr. FIG. 8B illustrates phase curves of the same analytic signals z(t) as the envelopes in FIG. 8A.

FIGS. 9A and 9B illustrates the signal data D01 and D02 of transmit signals without DC components as an example. FIG. 9A illustrates the signal data D01, which is represented as a sine chirp. FIG. 9B illustrates the signal data D02, which is including signed pulses with zero as a reference.

In FIG. 8A, envelopes E11 and E12 respectively plot the amplitudes of the analytic signals z(t) when the signal data D11 and D12 in FIGS. 5A and 5B are used for the transmit signals Sd. The envelopes E01 and E02 plot the amplitudes when the signal data D01 and D02 in FIGS. 9A and 9B are used. Phase curves θ11, θ12, θ01, and θ02 in FIG. 8B respectively plot the phases of the analytic signals z(t) of the envelopes E11, E12, E01, and E02 in FIG. 8A.

It is assumed that when the receive signal Sr of the analytic signal z(t) includes no DC component, irrespective of any DC component in the transmit signal Sd, highly accurate complex analysis can be conducted. For example, as illustrated in FIG. 8A, the peak time t₀ is detected from each of the envelopes E01 to E12. Additionally, as illustrated in FIG. 8B, the phase curves θ01 to θ12 have almost the same curved shape, and for example, each of the phase curves θ01 to θ12 has a steep gradient near the peak time t₀.

The aforementioned examples in FIGS. 8A and 8B represent ideal cases in which the receive signal Sr includes no DC component. However, it is assumed that in the displacement detection device 1, the receive signal Sr can include DC components attributable to, for example, various noises in practical applications. For example, due to ambient noises during the propagation of sound waves and deviations in the reference voltage at the wave receiver 11 or the individual circuits in the controller 13, the average amplitude of the receive signal Sr is shifted from a value of zero in practical use.

The signal data D01 and D02 illustrated as an example in FIGS. 9A and 9B have amplitudes that fluctuate between positive and negative values, using a voltage of “0” as a reference. In this manner, transmit signals that include no DC components are provided. The reference for the signal data D01 and D02 is unlikely to correspond to conditions, for example, when the thermophone stops heat generation. By contrast, unlike the examples in FIGS. 9A and 9B, the transmit signal Sd in the displacement detection device 1 of the present example embodiment uses a reference that corresponds to conditions when the thermophone stops heat generation, for example, as described for the signal data D11 and D12 in FIGS. 5A and 5B. The transmit signal Sd thus includes a DC component.

In FIGS. 10A and 10B respectively illustrate envelopes and phase curves of the analytic signals z(t) based on the signals in FIGS. 5A, 5B, 9A, and 9B and the receive signal Sr when the receive signal Sr includes a DC component. Similarly to FIG. 8A, envelopes E01 to E12 in FIG. 10A respectively plot the amplitudes of the analytic signals z(t) when the signal data D01 to D12 are used for the transmit signals Sd. Phase curves θ01 to θ12 in FIG. 10B respectively plot the phases of the analytic signals z(t) of the envelopes E01 to E12 in FIG. 10A.

With the signal data D01 and D02 in FIGS. 9A and 9B, for example, as illustrated in FIG. 10A, the envelopes E01 and E02 when the receive signal Sr includes a DC component are obtained similarly to the example in FIG. 8A, in which the receive signal includes no DC component. Accordingly, it is assumed that using a transmit signal including no DC component enables highly accurate complex analysis, irrespective of whether the receive signal Sr in the analytic signals z(t) of the envelopes E01 and E02 includes a DC component. However, the displacement detection device 1 of the present example embodiment uses, for example, as described above, the signal data D11 and D12 (FIGS. 5A and 5B) that controls heat generation by the thermophone. As a result, the transmit signal Sd includes a DC component.

In FIG. 10A, the envelopes E11 and E12 based on the transmit signals Sd generated using the signal data D11 and D12 exhibit deformed curves as compared to the example in FIG. 8A. In this case, using the analytic signals z(t) of the envelopes E11 and E12 is assumed to make conducting complex analysis with high accuracy difficult. For example, the envelope E11 exhibits relatively high amplitudes at sidelobes that differ from the peak, and the envelope E12 exhibits two peaks. Accordingly, it is expected that detecting peak times from the envelopes E11 and E12 with high accuracy can be difficult.

Further, also in FIG. 10B, the phase curves θ01 and θ02 are obtained similarly to the example in FIG. 8B, in which the receive signal Sr includes no DC component; by contrast, the phase curves θ11 and θ12 are significantly deformed as compared to the example in FIG. 8B. In this case, detecting displacements with high accuracy based on the phase differences using the phase ∠z(t) in the phase curves θ11 and θ12 is difficult.

As described above, when the receive signal Sr includes a DC component, calculating the envelope E(t) and the phase ∠z(t) of the analytic signal z(t) with high accuracy can be difficult for the displacement detection device 1, which uses the transmit signal Sd including a DC component. For example, a conceivable effect of DC components in the transmit signal Sd and the receive signal Sr is that, although the DC components in the transmit signal Sd and the receive signal Sr changes only the amplitudes of the cross-correlation function between the signals Sd and Sr, the peak time t₀ of the envelope E(t) of the analytic signal z(t) obtained from complexification of the cross-correlation function is shifted. In this case, a problem arises in which using parameters including the peak time t₀ makes it difficult for the displacement detection device 1 to detect information such as the distance to the object 3 with high accuracy.

To address this problem, the displacement detection device 1 of the present example embodiment performs an operation of removing the DC components while calculating the analytic signal z(t). With this configuration, for example, the peak time t₀ can be detected with high accuracy from the envelope E(t) of the analytic signal z(t) when the receive signal Sr includes a DC component. As a result, this configuration enables highly accurate detection of information such as the distance to the object 3.

### 2-3. Overall Operational Process

The overall operational process of the displacement detection device 1 of the present example embodiment, to detect displacements of the object 3, will be described with reference to FIGS. 4 and 11 to 14B.

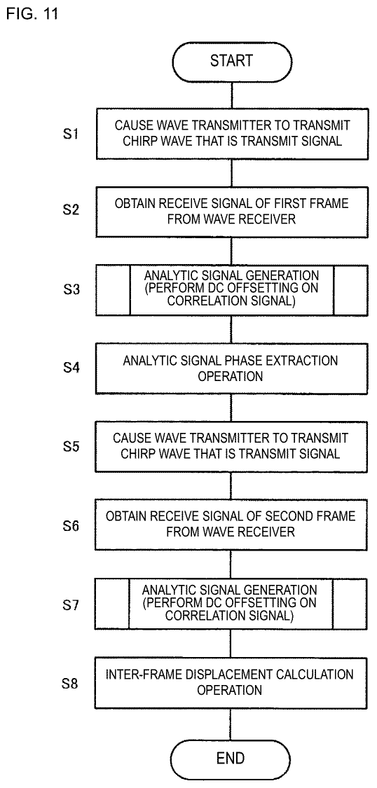

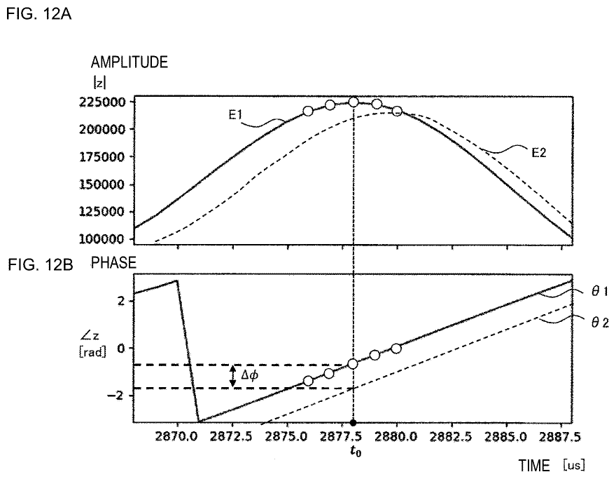

FIG. 11 is a flowchart illustrating an overall operational process of the displacement detection device 1 as an example. FIGS. 12A and 12B illustrate the overall operational process of the displacement detection device 1 according to the present example embodiment. The controller 13 of the displacement detection device 1 is configured or programmed to perform the operations illustrated in the flowchart in FIG. 11 repeatedly at predetermined periods, for example every two frames.

FIG. 12A illustrates, as an example, envelopes E1 and E2 of the analytic signals z(t) in a first frame and a second frame. FIG. 12B illustrates, as an example, phase curves θ1 and θ2 of the analytic signals z(t) in the first frame and the second frame. FIGS. 12A and 12B display five points near the peak time t₀ among the sampling points of the analytic signal z(t) on the envelope E1 and the phase curve θ1 for the first frame. The sampling point indicates a signal value z(t₁) at each time tᵢ of the analytic signal z(t), which is generated as a discrete signal.

In the flowchart in FIG. 11, firstly, the controller 13 of the displacement detection device 1 outputs the transmit signal Sd to the wave transmitter 10 and controls the wave transmitter 10 to transmit a chirp wave based on the transmit signal Sd (S1). Chirp waves enable displacement detection with high accuracy because chirp waves are attenuated to a relatively small degree, for example, during propagation in an air atmosphere.

After the chirp wave is transmitted (S1), the controller 13 obtains from the wave receiver 11 the receive signal Sr that represents the reception result for the first frame (S2). The reception result for the first frame is represented as an echo corresponding to the chirp wave transmitted in step S1.

Next, the controller 13 generates the analytic signal z(t) based on the cross-correlation function between the transmit signal Sd and the receive signal Sr (S3). In this analytic signal generation operation (S3), the displacement detection device 1 of the present example embodiment removes DC components in the cross-correlation function that is an example of a correlation signal. In step S3, the controller 13 operates as, for example, the functional units 131 to 134 and the DC offsetting unit 15 in FIG. 4 to generate the analytic signal z(t) based on the transmit signal Sd and the receive signal Sr in the first frame and removes DC components.

A cross-correlation function c(τ) between the signals Sd and Sr is given by the following expression:

$$c ( τ ) = {lim}_{T \to ∞} \frac{1}{T} {\int }_{- \frac{T}{2}}^{\frac{2}{T}} {s}_{d} ( t ) {s}_{r} ( t + τ ) dt \qquad [ Math . 1 ]$$

where T represents the period of one frame, and τ represents the delay time. The cross-correlation function c(τ) represents correlations when the delay time i exists between the two signals Sd and Sr.

In the displacement detection device 1 of the present example embodiment, the controller 13 performs a computational operation of removing a DC component in the cross spectrum corresponding to the cross-correlation function c(τ) in the frequency domain. The controller 13 outputs the in-phase component I that represents the cross-correlation function c(τ) by calculating the inverse Fourier transform of the cross spectrum. The controller 13 also outputs the quadrature component Q by calculating the inverse Fourier transform based on the Hilbert transform of the cross spectrum. As a result, the analytic signal z(t)=I(t)+jQ(t) is obtained using the components I and Q (j is the imaginary unit).

Subsequently, the controller 13 operates as, for example, the analytical processing unit 135 in FIG. 4 and performs an operation of extracting phase information from the analytic signal z(t) for the first frame after the DC components have been removed (S4).

In this analytic signal phase extraction operation (S4), the controller 13 detects the peak time t₀ in the envelope E(t) of the analytic signal z(t) and extracts phase information including the phase ∠z(t) to the phase ∠z(₀o) at the peak time t₀. To detect the peak time t₀, the controller 13 calculates the envelope E(t)=|z(t)| by determining the square root of the sum of the squares of the in-phase component I and the quadrature component Q.

In FIGS. 12A and 12B illustrate the regions near the peak time t₀ in an enlarged manner, corresponding to FIGS. 7A and 7B. In the example in FIG. 12A, the peak time t₀ is detected in the envelope E1 for the first frame. Using the peak time t₀ as a reference, phase information is extracted from the phase ∠z(t) of the phase curve θ1 for the first frame illustrated in FIG. 12B.

Using the in-phase component I(tᵢ) and the quadrature component Q(tᵢ) at the time tᵢ, a phase ∠z(tᵢ) at the time tᵢ is given by the following expression:

∠z(tᵢ)=arctan(Q(tᵢ)/I(tᵢ))

Subsequently, similarly to steps S1 and S2, the controller 13 performs transmission and reception of a chirp wave for the second time and receives the receive signal Sr that corresponds to the transmit signal Sd in the second frame (S5, S6).

Similarly to step S3, the controller 13 removes DC components from the transmit signal Sd and the receive signal Sr in the second frame while calculating the analytic signal z(t) (S7). This analytic signal generation operation (S3, S7) will be detailed later.

Next, the controller 13 performs an operation of calculating a displacement amount Δx of the object 3 based on the difference in phase information between the two frames, by using the phase information for the first frame and the phase information about the analytic signal z(t) generated from the transmit signal Sd and the receive signal Sr in the second frame (S8). In this inter-frame displacement calculation operation (S8), the controller 13 operates as, for example, the analytical processing unit 135 illustrated in FIG. 4 and extracts the phase information about the analytic signal z(t) in the second frame. In the example in FIG. 12B, the phase information for the second frame is extracted from the phase ∠z(t) of the phase curve θ2 for the second frame, for example, using the peak time t₀ in the first frame as a reference.

In the inter-frame displacement calculation operation (S8), the controller 13 calculates a phase difference Δp between the frames at the peak time t₀ by calculating the difference in phase information between the frames. The controller 13 subsequently calculates the displacement amount Δx between the frames by converting this peak phase difference Δφ.

The displacement amount Δx between frames is given by the following expression:

$$Δ x = \frac{c}{2} \frac{Δφ}{2 π {f}_{c}} \qquad [ Math . 2 ]$$

where c represents the acoustic velocity, π represents the ratio of a circle's circumference to its diameter, and fc represents the center frequency of the analytic signal z(t). In the inter-frame displacement calculation operation (S8) of the present example embodiment, fc is derived from the analytic signal z(t) in the first frame. For example, fc is calculated as the gradient (in other words, the instantaneous frequency) of the phase ∠z(t₀) at the peak time t₀. For example, in view of calculating the gradient of the phase ∠z(t₀) with high accuracy, the controller 13 calculates, as the instantaneous frequency fc, the slope of the regression line based on phases at sampling points near the peak time t₀, in other words, the regression coefficient.

According to the operations described above, the displacement detection device 1 transmits and receives a chirp wave two time (S1, S2, S5, S6) and removes a DC component in the cross spectrum in each time of generating the analytic signal z(t) (S3, S7). The displacement detection device 1 subsequently calculates the displacement amount Δx based on the peak phase difference Δφ of the analytic signal z(t) between the two time (S8). In this manner, when both the transmit signal Sd and the receive signal Sr include DC components, the cross-correlation function c(τ) corresponding to the cross spectrum after removing the DC components enables highly accurate complex analysis.

For example, by performing complex analysis using the in-phase component I and the quadrature component Q, which constitute the cross-correlation function c(τ), the peak time t₀ of the envelope E(t) of the analytic signal z(t) is detected with high accuracy, and the phase information about the analytic signal z(t) is extracted with high accuracy. Based on the peak time t₀ and the phase information, for example, by converting the peak phase difference Δφ, the displacement amount Δx is calculated with high accuracy.

For example, the operations described above can reduce detection errors arising from the attenuation of the receive signal Sr in an air atmosphere and from superimposed noises. As a result, small displacements of the object 3 can be detected with high accuracy without making contact with the object 3. The displacement detection device 1 is able to perform detection without making contact with the object 3. This configuration facilitates the detection of small displacements.

Regarding the inter-frame displacement calculation operation (S8), an example in which only the phase information is used for the analytic signal z(t) in the second frame has been described. Instead, for example, the displacement detection device 1 may also detect the peak time of the analytic signal z(t) in the second frame and use the peak time in the second frame together with the peak time t₀ in the first frame to calculate the displacement amount Δx. The displacement detection device 1 may also use the peak time in the second frame to perform the analytic signal phase extraction operation (S4) for the subsequent execution period. In the inter-frame displacement calculation operation (S8), the peak phase difference may be calculated using the peak time in the second frame as a reference. For example, the displacement detection device 1 may detect the peak time of the analytic signal z(t) in the second frame instead of the first frame.

The foregoing has described an example in which the operations in FIG. 11 are performed every two frames. However, the operations in FIG. 11 may be performed at periods different from this example. For example, the operations in FIG. 11 may be performed every one frame. The transmit signal Sd and the receive signal Sr in the transmission and reception of a chirp wave for the second time (S5, S6) may be stored, and the subsequent execution period may start from the analytic signal phase extraction operation (S4) while using the stored signals Sd and Sr.

### 2-3-1. Analytic Signal Generation Operation

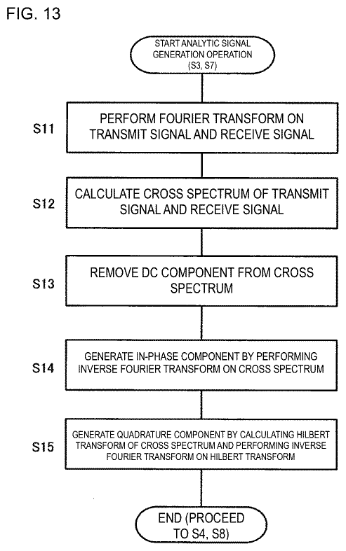

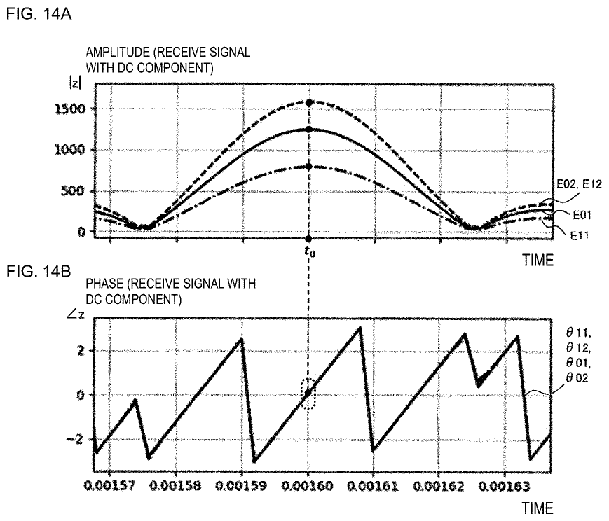

The analytic signal generation operation in steps S3 and S7 in FIG. 11 will be described with reference to FIGS. 13, 14A, and 14B.

FIG. 13 is a flowchart illustrating the analytic signal generation operation (S3, S7) of the displacement detection device 1 of the present example embodiment as an example. FIGS. 14A and 14B illustrate effects of the displacement detection device 1.

For example, when the operation illustrated in the flowchart in FIG. 13 corresponds to step S3 in FIG. 11, the operation starts in the state in which the transmit signal Sd output by the wave transmitter 10 in the first frame in step S1 and the receive signal Sr obtained in the first frame in step S2 are stored. In step S7, the operation starts in the state in which, in the same manner as the first frame, the transmit signal Sd in the second frame in step S5 and the receive signal Sr in the second frame in step S6 are stored.

Firstly, the controller 13 of the displacement detection device 1 operates as, for example, the FFT unit 131 in FIG. 4 and calculates the Fourier transform of the transmit signal Sd and the receive signal Sr (S11).

The controller 13 operates as the cross spectrum calculation unit 132 and calculates the cross spectrum of the transmit signal Sd and the receive signal Sr based on the calculation result of the Fourier transform of the transmit signal Sd and the receive signal Sr (S12). The cross spectrum is calculated as the product of the calculation results obtained by the Fourier transform for the signals Sd and Sr, converted from the time domain to the frequency domain.

Next, the controller 13 is configured or programmed to operate as, for example, the DC offsetting unit 15 and performs a calculation to remove a DC component in the cross spectrum of the transmit signal Sd and the receive signal Sr (S13). When f represents frequency, the Fourier transform of the cross-correlation function c(τ) between the transmit signal Sd and the receive signal Sr yields the cross spectrum S(f) as given by the following expression:

S(f)∫_{-∞}^{∞}c(τ)e^{-2πfτ}dτ [Math. 3]

In step S13, the controller 13 performs a calculation to set a value S(0) of the cross spectrum S(f) when the frequency f is “0” to a value of zero. According to the expression presented above, S(0) corresponds to the DC component of the cross-correlation function c(τ). By performing the calculation on the cross spectrum S(f), the DC component of the cross-correlation function c(τ) is removed using the frequency domain.

Subsequently, the controller 13 operates as, for example, the IFFT unit 134b in FIG. 4 and generates the in-phase component I of the analytic signal z(t) by calculating the inverse Fourier transform of the cross spectrum S(f) after the DC component has been removed (S14).

The controller 13 generates the quadrature component Q of the analytic signal z(t) by, for example, firstly operating as the Hilbert transform unit 133, calculating the Hilbert transform of the cross spectrum S(f) after the DC component has been removed and, secondly operating as the IFFT unit 134a, calculating the inverse Fourier transform of the Hilbert transform (S15).

For example, after generating the quadrature component Q (S15), the controller 13 stores the in-phase component I and the quadrature component Q, which are generated in step S14, in the memory 14 and ends the analytic signal generation operation (S3, S7). Subsequently, the process proceeds to step S4 or S8 in FIG. 11.

According to the operation described above, a DC component is removed in the cross spectrum S(f) of the transmit signal Sd and the receive signal Sr (S13), and the in-phase component I and the quadrature component Q of the analytic signal z(t) are generated using the cross spectrum S(f) after the DC component has been removed (S14, S15). Although both the transmit signal Sd and the receive signal Sr include DC components, this configuration suppresses the DC component in the cross spectrum corresponding to the cross-correlation function between the signals Sd and Sr. By performing the cross spectrum, the peak time t₀ of the envelope E(t) based on the in-phase component I and the quadrature component Q can be detected with high accuracy (S4), and accordingly, the phase information about the region near the peak time t₀ can also be extracted with high accuracy (S4, S8).

In FIGS. 14A and 14B respectively illustrate envelopes E(t) and phase curves θ(t) of the analytic signals that are generated, when the receive signal Sr includes a DC component similarly to FIGS. 10A and 10B, after the DC component is removed from the cross-correlation function between the individual signals in FIGS. 5A, 5B, 9A, and 9B and the receive signal Sr (S13).

Similarly to FIGS. 8A, 8B, 10A, and 10B, envelopes E11 and E12 in FIG. 14A respectively correspond to the cases in which the signal data D11 and D12 including DC components are used for the transmit signal Sd. Envelopes E01 and E02 in FIG. 14A correspond to the cases in which the signal data D01 and D02 including no DC components are used. Phase curves θ01 to θ12 in FIG. 14B respectively plot the phases of the analytic signals z(t) of the envelopes E01 to E12 in FIG. 14A.

In FIGS. 14A and 14B indicate that when both the receive signal Sr and the transmit signal Sd include DC components, the obtained envelopes E11 and E12 and phase curves θ11 and θ12 are similar to the case in which the ideal receive signal Sr including no DC component is used, which is illustrated in FIGS. 8A and 8B. As described above, the analytic signal generation operation with DC component removal (S3, S7) obtains with high accuracy the envelope E(t) and the phase ∠z(t) in the phase curve θ(τ) when both the receive signal Sr and the transmit signal Sd include DC components, unlike the example in FIGS. 10A and 10B.

The displacement detection device 1 of the present example embodiment removes the DC component in the cross spectrum S(f) in the frequency domain (S13). This case simply requires substituting a value of zero for S(0). This configuration thus reduces the amount of calculation. As a result, the displacement detection device 1 detects information such as distance with high accuracy, while reducing processing loads.

Further, for example, when the DC component of the cross spectrum alters due to, for example, variations in the DC component of the receive signal Sr, the DC component can be removed without any need for additional calculations. Furthermore, for example, the memory 14 does not need to store, for example, additional data and calculated values to be used for DC component removal, as well as the signal data D11 (or the signal data D12) corresponding to the transmit signal Sd. With this configuration, DC components are efficiently removed.

The foregoing has described the example in which, during the operations described above, the in-phase component I is generated first (S14), and the quadrature component Q is subsequently generated (S15). However, steps S14 and S15 are not necessarily performed in this order. For example, the quadrature component may be generated first (S15), and the in-phase component may be subsequently generated (S14).

### 3. Conclusion

As described above, in the present example embodiment, the displacement detection device 1, which is an example of an object detection device, includes the wave transmitter 10, the wave receiver 11, and the controller 13. The wave transmitter 10 transmits a sound wave to the object 3. The wave receiver 11 receives a sound wave and generate the receive signal Sr that represents the reception result. The controller 13 controls transmission of a sound wave by the wave transmitter 10 and obtain the receive signal Sr from the wave receiver 11. The controller 13 outputs the transmit signal Sd to cause the wave transmitter 10 to transmit a sound wave (S1, S5) and obtain the corresponding receive signal Sr (S2, S6). By complex analysis to perform complexification on the cross-correlation function c(τ) (an example of a correlation signal) that represents the correlation between the transmit signal Sd and the receive signal Sr (S3, S4, S7, S8), the controller 13 calculates the displacement amount Δx (S8), which is an example of generating detection information about the object 3. The displacement detection device 1 further includes the DC offsetting unit 15 as a functional element of the controller 13. The DC offsetting unit 15 is an example of a signal correcting unit (signal corrector) that corrects the correlation signal to mitigate a direct-current (DC) component in the correlation signal targeted for complex analysis (S3, S7).

The displacement detection device 1 mitigates the DC component in the correlation signal of the transmit signal Sd and the receive signal Sr (S3, S7). With this configuration, when both the transmit signal Sd and the receive signal Sr include DC components, the complexificated correlation signal is not affected by the DC components. As a result, the detection information such as displacements of the object 3 is generated with high accuracy by using the complexificated correlation signal.

In the present example embodiment, by performing a computational operation of removing the DC component in the cross spectrum including the frequency components of the cross-correlation function c(τ) (an example of a correlation signal) (S13), the DC offsetting unit 15 (an example of a signal correcting unit or signal corrector) corrects the corresponding signal (S3, S7). This configuration corrects the correlation signal while reducing the amount of calculation when the DC component of the cross spectrum in the frequency domain is removed.

In the present example embodiment, as an example of converting the transmit signal Sd into the transmit spectrum and converting the receive signal Sr into the receive spectrum, the controller 13 calculates the Fourier transform of the transmit signal Sd and the receive signal Sr (S11) and calculates the cross spectrum based on the calculation results of the Fourier transform (an example of a transmit spectrum and a receive spectrum) (S12). The DC offsetting unit 15, which is an example of a signal correcting unit or signal corrector, corrects the correlation signal (S3, S7) by performing a computational operation of removing the DC component on the cross spectrum (S13). With this configuration, the correlation signal is efficiently corrected in complex analysis of the correlation signal.

In the present example embodiment, the controller 13 generates, in complex analysis of the correlation signal, the analytic signal z(t) having the amplitude |z(t)| and the phase ∠z(t) that are determined by the correlation between the transmit signal Sd and the receive signal Sr (S3, S7, S11 to S15). As a result, various analyses using both the amplitude |z(t)| and the phase ∠z(t) of the analytic signal z(t), or either the amplitude |z(t)| or the phase ∠z(t) can be conducted.

In the present example embodiment, the controller 13 calculates the envelope E(t) of the analytic signal z(t), detects a timing when the amplitude |z(t)| is largest based on the calculated envelope(t) (S4), and calculates the displacement amount Δx of the object 3 (S8), which is an example of generating detection information, based on the peak time t₀, which is an example of a timing detected from the envelope E(t). The detection information is not limited to displacements of the object 3. The detection information may be, for example, the distance to the object 3 at the peak time t₀.

In the present example embodiment, the controller 13 calculates the quadrature component Q of the correlation signal, using the cross spectrum, which is an example of a correlation signal after the DC component of the correlation signal is mitigated by the DC offsetting unit 15 (an example of a signal correcting unit or signal corrector) (S15) and uses the quadrature component Q for complex analysis. With this configuration, using the quadrature component Q enables the generation of the detection information about the object 3 such as the distance to the object 3 with higher accuracy than when using, for example, only the correlation signal.

In the present example embodiment, the correlation signal is determined by the cross-correlation function between the transmit signal Sd and the receive signal Sr, and the controller 13 performs complex analysis by performing complexification on the cross-correlation function using the in-phase component I and the quadrature component Q that represent the correlation signal. With this configuration, in complex analysis, the analytic signal z(t) is generated from the in-phase component I and the quadrature component Q.

In the present example embodiment, the wave transmitter 10 includes a thermophone configured to transmit a sound wave by generating heat in response to the transmit signal Sd that includes a DC component. Using a thermophone enables the generation of sound waves that have wide-range frequency characteristics, such as chirp waves.

The object detection method in the present example embodiment includes a step of outputting the transmit signal Sd to the wave transmitter 10 to cause the wave transmitter 10 to transmit a sound wave toward the object 3 (S1, S4), a step of obtaining the receive signal Sr corresponding to the transmitted sound wave from the wave receiver 11 configured to receive a sound wave and generate a receive signal that represents a reception result (S2, S5), a step of, by complex analysis to perform complexification on the cross-correlation function c(τ) (an example of a correlation signal) that represents the correlation between the transmit signal Sd and the receive signal Sr (S3, S4, S7, S8), calculating the displacement amount Δx of the object 3 (S8), which is an example of generating detection information about the object 3, and a step of correcting any of the transmit signal Sd, the receive signal Sr, and the correlation signal to mitigate a direct-current (DC) component in the correlation signal that is targeted for the complex analysis. An example of correcting the transmit signal Sd or the receive signal Sr will be described later.

The present example embodiment provides a non-transitory computer-readable medium including a program to cause the controller 13 to perform the object detection method described above. The object detection method and non-transitory computer-readable medium including a program enable accurate generation of the detection information about the object 3 as a result of transmitting and receiving sound waves.

### Second Example Embodiment

In the first example embodiment, the displacement detection device 1 that is configured to, in the analytic signal generation operation (S3, S7), remove a DC component of the cross spectrum (S15) has been described. A second example embodiment provides a displacement detection device 1 that is configured to, in the analytic signal generation operation, remove a DC component of the receive signal Sd after the receive signal Sd has been Fourier-transformed.

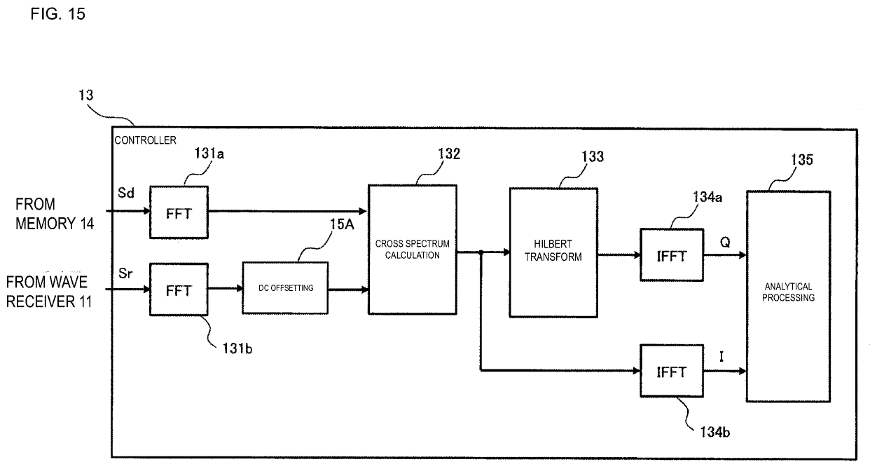

FIG. 15 is a block diagram illustrating functional elements of a controller 13 of the displacement detection device 1 according to the second example embodiment. The controller 13 of the present example embodiment includes, as well as the same functional units 131 to 135 as in the first example embodiment, a DC offsetting unit 15A to process the receive signal Sr that has been Fourier-transformed by the FFT unit 131b, as a replacement for the DC offsetting unit 15.

In the controller 13 of the present example embodiment, the FFT unit 131b is operable to output the calculation result of the Fourier transform of the receive signal Sr to the DC offsetting unit 15A. The DC offsetting unit 15A is operable to remove the DC component in the receive signal Sr that has been transformed from the time domain to the frequency domain using the Fourier transform. The calculation result of the Fourier transform is determined by the multiple frequency components included in the receive signal Sr. The calculation result of the Fourier transform is an example of a receive spectrum in the present example embodiment.

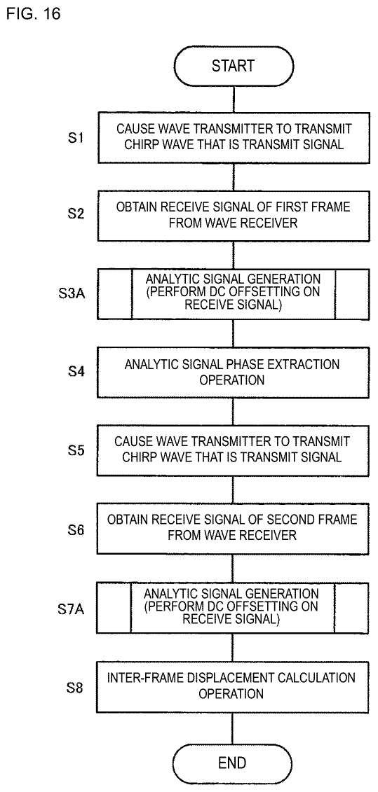

FIG. 16 is a flowchart illustrating an overall operational process of the displacement detection device 1 according to the second example embodiment as an example. In the present example embodiment, the controller 13 performs an analytic signal generation operation (S3A, S7A) that includes removing the DC component in the receive signal Sr after the receive signal Sr has been Fourier-transformed, as a replacement for the analytic signal generation operation (S3, S7) according to the first example embodiment, which includes removing the DC component in the cross spectrum (S13).

In the analytic signal generation operation (S3A, S7A) according to the present example embodiment, firstly, for example, similarly to step S11 in FIG. 13, the controller 13 calculates the Fourier transform of the transmit signal Sd and the receive signal Sr. Next, the controller 13 operates as the DC offsetting unit 15A and performs a computational operation of removing the DC component included in the receive signal Sr using the calculation result of the Fourier transform of the receive signal Sr. The controller 13 performs an operation, for example, such that the component corresponding to a frequency of “0” of the Fourier-transformed receive signal Sr is set to a value of zero.

The controller 13 subsequently calculates, for example, similarly to step S12 in FIG. 13, the cross spectrum of the transmit signal Sd and the receive signal Sr, based on the product of the Fourier-transformed transmit signal Sd and the Fourier-transformed receive signal Sr after the DC component has been removed from the receive signal Sr. As a result, the component corresponding to a frequency of “0” of the cross spectrum is also set to a value of zero. This configuration yields a cross spectrum that includes no DC component. The controller 13 generates the in-phase component I and the quadrature component Q of the analytic signal z(t), based on the calculated cross spectrum.

According to the operations described above, the DC component is removed from the Fourier-transformed receive signal Sr, and the analytic signal z(t) is generated from the cross spectrum of the transmit signal Sd and the receive signal Sr after the DC component has been removed from the receive signal Sr (S3A, S7A). This configuration removes the DC component of the receive signal Sr in the frequency domain, while reducing the amount of calculation. The DC component in the cross spectrum is also removed. By performing complex analysis on the cross-correlation function c(τ) corresponding to the cross spectrum, the envelope E(t) and the phase ∠z(t) of the analytic signal z(t) are calculated with high accuracy.

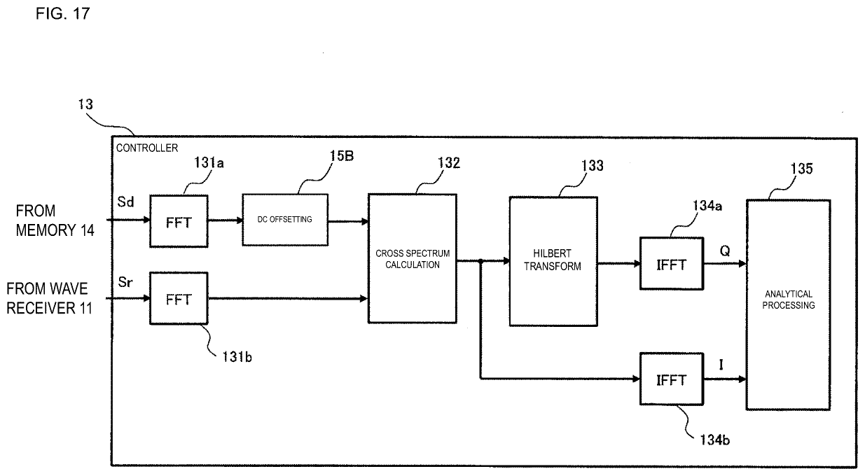

The foregoing example has described the displacement detection device 1 that is configured to, in the analytic signal generation operation (S3A, S7A), remove the DC component in the Fourier-transformed receive signal Sr. However, the target for removing the DC component is not necessarily the receive signal Sr and may be, for example, the transmit signal Sd. A displacement detection device 1 according to a modification of the second example embodiment will be described with reference to FIG. 17.

The displacement detection device 1 of the present modification includes, for example, while having a configuration similar to the second example embodiment, a DC offsetting unit 15B, which may be a functional element of the controller 13, as a replacement for the DC offsetting unit 15A, as illustrated in FIG. 17. The DC offsetting unit 15B is operable to perform a computational operation of removing the DC component in the transmit signal Sd that has been Fourier-transformed by the FFT unit 131a. The DC offsetting unit 15B outputs, to the cross spectrum calculation unit 132, the Fourier-transformed transmit signal Sd after the DC component has been removed from the transmit signal Sd.

In the present modification, the controller 13 performs an operation of removing a DC component in the Fourier-transformed transmit signal Sr instead of the receive signal Sr in the same analytic signal generation operation (S3A, S7A) as in the second example embodiment. As a result, similarly to the removal of the DC component in the receive signal Sr, this configuration removes the DC component of the transmit signal Sd while reducing the amount of calculation. Based on the transmit signal Sd after the DC component has been removed from the transmit signal Sd in the frequency domain and the receive signal Sr, this configuration also calculates the cross spectrum that includes no DC component. The Fourier-transformed transmit signal Sd is an example of a transmit spectrum in the present example embodiment. The DC component removal method in the present modification and the removal methods in the example embodiments described above may be combined in any appropriate manner.

As described above, in the present example embodiment, the displacement detection device 1, which is an example of an object detection device, while having a configuration similar to the first example embodiment, the DC offsetting unit 15A, which is an example of a signal correcting unit or signal corrector, as a replacement for the DC offsetting unit 15. The DC offsetting unit 15A is operable to correct the receive signal Sr to mitigate the DC component in the cross-correlation function c(τ), which is an example of a correlation signal targeted for complex analysis, between the transmit signal Sd and the receive signal Sr (S3A, S7A). In the modification of the present example embodiment, the displacement detection device 1 includes the DC offsetting unit 15B, which is an example of a signal correcting unit or signal corrector, as a replacement for the DC offsetting unit 15A. The DC offsetting unit 15B is operable to correct the transmit signal Sd to mitigate the DC component in the correlation signal.

The displacement detection device 1 described above corrects either the transmit signal Sd or the receive signal Sr to mitigate the DC component of the correlation signal. This configuration also enables generation of detection information such as displacements of the object 3 with high accuracy by complex analysis based on the corrected transmit signal Sd or the corrected receive signal Sr.

In the present example embodiment, the DC offsetting units 15A and 15B (an example of a signal correcting unit or signal corrector) perform a computational operation of removing the DC component in either the calculation result of the Fourier transform of the receive signal Sr, which is an example of a receive spectrum including the frequency components of the receive signal Sr or the calculation result of the Fourier transform of the transmit signal Sd, which is an example of a transmit spectrum including the frequency components of the transmit signal Sd, to correct the corresponding signal (S3A, S7A). This configuration removes the DC component of the transmit signal Sd or the receive signal Sr in the frequency domain while reducing the amount of calculation.

In the present example embodiment, the controller 13 calculates the Fourier transform of the transmit signal Sd and the Fourier transform of the receive signal Sr as an example of converting the transmit signal Sd to a transmit spectrum and the receive signal Sr to a receive spectrum (S11). The DC offsetting units 15A and 15B (an example of a signal correcting unit or signal corrector) perform a computational operation of removing the DC component on either the calculation result of the Fourier transform of the transmit signal Sd or the calculation result of the Fourier transform of the receive signal Sr to correct the corresponding signal selected from the transmit signal Sd and the receive signal Sr (S3A, S7A). This configuration yields a cross spectrum that includes no DC component, using the corrected transmit signal Sd after the Fourier transform or the corrected receive signal Sr after the Fourier transform (S12).

According to the example embodiments described above, in the displacement detection device 1, which is an example of an object detection device, the DC offsetting units 15, 15A, and 15B (an example of a signal correcting unit or signal corrector) corrects a correlation signal, the receive signal Sr, or the transmit signal Sd to mitigate the DC component in the cross-correlation function c(τ), which is an example of a correlation signal targeted for complex analysis (S3, S7, S3A, S7A).

Further, according to the example embodiments described above, the DC offsetting units 15, 15A, and 15B perform a computational operation of removing the DC component in the cross spectrum including the frequency components of the correlation signal, the Fourier-transformed receive signal Sr, which is an example of a receive spectrum including the frequency components of the receive signal Sr, or the Fourier-transformed transmit signal Sd, which is an example of a transmit spectrum including the frequency components of the transmit signal Sd, to correct the corresponding signal (S3, S7, S13, S3A, S7A).

### Third Example Embodiment

In the second example embodiment, the displacement detection device 1 configured to remove the DC component in the frequency domain from the Fourier-transformed receive signal Sr has been described. A third example embodiment presents a displacement detection device 1 that is configured to remove a DC component of the receive signal Sr before the Fourier transform in the time domain.

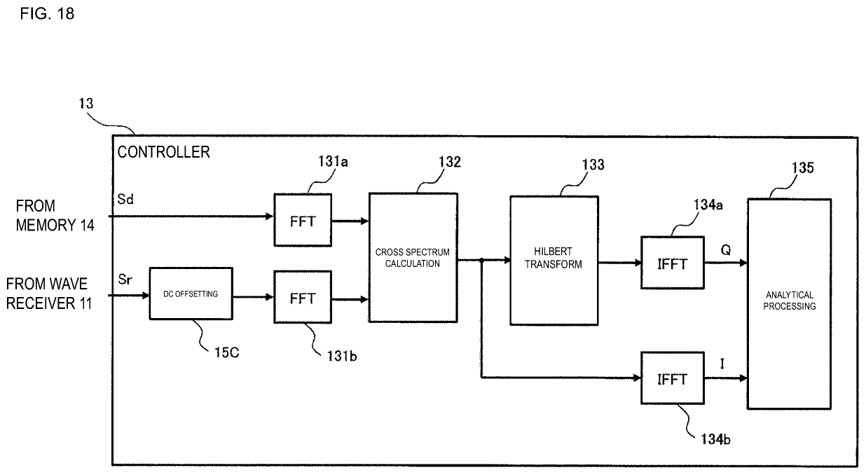

FIG. 18 is a block diagram illustrating functional elements of a controller 13 of the displacement detection device 1 according to the third example embodiment. In the displacement detection device 1 of the present example embodiment, the controller 13 includes, while having a configuration similar to the first example embodiment, a DC offsetting unit 15C to remove a DC component of the receive signal Sr in the time domain. The DC offsetting unit 15C performs a computational operation to correct the receive signal Sr to cancel out the DC component in the receive signal Sr inputted to the controller 13 and outputs the calculation result to the FFT unit 131b.

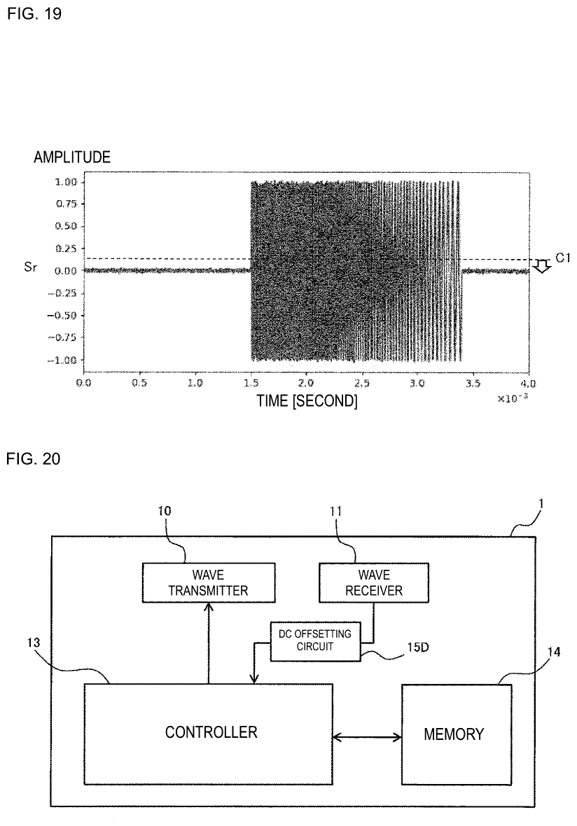

FIG. 19 illustrates an operation of the displacement detection device 1 according to the third example embodiment. FIG. 19 illustrates the receive signal Sr including a DC component as an example. The DC component in the receive signal Sr in FIG. 19 corresponds to an average amplitude C1 in the period of one frame. In the displacement detection device 1 of the present example embodiment, the controller 13 operates as the DC offsetting unit 15C and calculates the average C1 for one frame based on the receive signal Sr inputted from the wave receiver 11 and subtracts the average C1 from the amplitudes of the receive signal Sr at the individual time points in the frame.

As a result, using the receive signal Sr after the DC component has been removed in the time domain and the transmit signal Sd, the cross spectrum that includes no DC component is calculated, and the in-phase component I and the quadrature component Q are generated, for example, by performing the operations of the functional units 131 to 135. This configuration also enables calculation of the envelope E(t) and the phase ∠z(t) of the analytic signal z(t) with high accuracy.

In the example described above, the displacement detection device 1 configured to remove the DC component in the time domain before the Fourier transform by calculating the average C1 of the receive signal Sr and subtracting the average C1 has been described. Removing the DC component of the receive signal Sr in the time domain is not limited to this example. A displacement detection device 1 according to a modification of the third example embodiment will be described with reference to FIG. 20.

The displacement detection device 1 of the present modification additionally includes, for example, while having a configuration similar to the first example embodiment, a DC offsetting circuit 15D as illustrated in FIG. 20, as a replacement for the DC offsetting unit 15C of the controller 13 in the third example embodiment. The DC offsetting circuit 15D is able to mitigate the DC component in the reception result of receiving a sound wave by the wave receiver 11. The wave receiver 11 of the present modification, for example, outputs to the DC offsetting circuit 15D an analog signal that is an electrical signal representing a reception result.

The DC offsetting circuit 15D includes a variable resistor. The DC offsetting circuit 15D is operable to control, for example, the reference voltage to be inputted to an A/D converter of the controller 13 so as to remove the DC component of the analog signal from the wave receiver 11. This configuration enables the correction of the receive signal Sr, for example, to mitigate the DC component of the receive signal Sr due to deviations in the reference voltage.

As described above, in the present example embodiment, the DC offsetting unit 15C, which is an example of a signal correcting unit or signal corrector, corrects the receive signal Sr to cancel out the DC component in the receive signal Sr generated by the wave receiver 11 and outputs the corrected receive signal Sr to the FFT unit 131b of the controller 13. In the modification of the present example embodiment, the DC offsetting circuit 15D, which is an example of a signal correcting unit or signal corrector, corrects an analog signal that represents a reception result from the wave receiver 11, which is an example of a receive signal generated by the wave receiver 11, to cancel out the DC component in the analog signal and outputs the corrected analog signal to the A/D converter of the controller 13. By performing this correction as well, a correlation signal after the DC component is mitigated is generated. As such, this configuration achieves the same effect as the example embodiments described above.

### Other Example Embodiments

The foregoing has described the first to third example embodiments as examples of the present invention. However, the present invention is not limited to these examples and may be implemented as other example embodiments. The following describes other example embodiments.

In the example embodiments described above, the example in which the displacement detection device 1 generates the analytic signal z(t) and uses the envelope E(t) and the phase ∠z(t) in complex analysis to detect a displacement of the object 3 has been described. In the present example embodiment, the displacement detection device 1 does not necessarily perform the complex analysis performed in the example embodiments described above. Instead, the displacement detection device 1 may perform various kinds of complex analysis. For example, the displacement detection device 1 of the present example embodiment may analyze only the envelope E(t) of the generated analytic signal z(t) in complex analysis. For example, the displacement detection device 1 may detect the peak time of the envelope E(t) for individual frames and compare the peak times of two consecutive frames to measure the amount of displacement.

Also in the present example embodiment, the peak time is detected with high accuracy from the envelope E(t) as a result of removing the DC component included in at least any of the transmit signal Sd, the receive signal Sr, and the cross spectrum (or the cross-correlation function in the time domain). This configuration also enables displacement detection with high accuracy.

The displacement detection device 1 of the present example embodiment may be used for detection of the distance to the object 3, in addition to or instead of detection of displacements of the object 3. For example, by performing the measurement operation described above for individual frames, the displacement detection device 1 of the present example embodiment may detect the peak time in the envelope E(t) and detect the distance to the object 3 using the detected peak time. Also in this case, similarly to the example embodiments described above, by performing an operation of removing the DC component before generating the quadrature component Q, the distance to the object 3 is detected with high accuracy. Displacements of the object 3 and/or the distance to the object 3 are an example of detection information about the object 3 in the present example embodiment.

As described above, in the present example embodiment, the detection information includes at least one of a displacement of the object 3 between two consecutive frames, which is an example of a predetermined measurement period, and a distance to the object 3. The displacement detection device 1 of the present example embodiment measures the amount of displacement and/or the distance with high accuracy by mitigating the DC component and accordingly generates the detection information with high accuracy.

Example embodiments of the present invention are not limited to the above-described case including the analysis of the envelope E(t). Example embodiments of the present invention may be used for, for example, only the analysis of the phase ∠z(t) of the analytic signal z(t). Further, example embodiments of the present invention are not limited to the analysis of the envelope E(t) and/or the phase ∠z(t). Example embodiments of the present invention may be used for, for example, various analyses using the quadrature component Q.

In the example embodiments described above, the example in which the analytic signal z(t) is generated using the transmit signal Sd that includes a DC component has been described. The displacement detection device 1 of the present example embodiment includes the memory 14 to store signal data for correction. The memory 14 is an example of a signal correcting unit or signal corrector. The signal data for correction corresponds to a signal that exhibits a chirp similarly to the transmit signal Sd but includes no DC component. For example, the signal data D01 and D02 illustrated in FIGS. 9A and 9B may be used as the signal data for correction. The displacement detection device 1 corrects the transmit signal Sd to mitigate the DC component in the cross spectrum (an example of a correlation signal) by inputting the signal data for correction stored as the transmit signal Sd in the memory 14 to the controller 13 in the analytic signal generation operation.

With this configuration, when the receive signal Sr includes a DC component, similarly to the example embodiments described above, the envelope E(t) and the phase ∠z(t) of the analytic signal z(t) are calculated with high accuracy.

In the third example embodiment, the example in which the receive signal Sr is corrected to mitigate the DC component of the receive signal Sr in the time domain has been described. In the present example embodiment, alternatively to the receive signal Sr, for example, similarly to the third example embodiment, by calculating the average in the cross-correlation function c(τ), which is an example of a correlation signal, and subtracting the average, the correlation signal may be corrected to remove the DC component in the time domain. Similarly, the transmit signal Sd may be corrected to remove the DC component in the time domain.

In the example embodiments described above, the example in which the controller 13 calculates, as the in-phase component I, the cross-correlation function by calculating the cross spectrum of the transmit signal Sd and the receive signal Sr and subsequently calculating the inverse Fourier transform of the cross spectrum has been described. In the present example embodiment, the controller 13 may, for example, calculate the cross-correlation function by directly performing the multiply-accumulate operation on the transmit signal Sd and the receive signal Sr and correct any of the transmit signal Sd, the receive signal Sr, and the cross-correlation function to mitigate the DC component in the corresponding signal in the time domain. For example, the controller 13 may include a circuit to perform the multiply-accumulate operation, such as a field-programmable gate array (FPGA). The analytic signal generation by the controller 13 is not necessarily implemented using the Hilbert transform. The analytic signal generation by the controller 13 may be implemented using, for example, the quadrature detection function.

In the example embodiments described above, the example in which the displacement detection device 1 includes one wave transmitter 10 and one wave receiver 11 has been described. In the present example embodiment, the displacement detection device 1 may include multiple wave transmitters, multiple wave receivers, or both.

Example embodiments of the present invention provide object detection devices, methods, and computer-readable media including programs to analyze signals including DC components, for detection of, for example, distance to an object.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An object detection device comprising:
a wave transmitter to transmit a sound wave to an object;
a wave receiver to receive a sound wave and generate a receive signal that represents a reception result; and
a controller configured or programmed to control transmission of a sound wave by the wave transmitter and obtain the receive signal from the wave receiver; wherein
the controller is configured or programmed to:
output a transmit signal to cause the wave transmitter to transmit a sound wave and obtain a corresponding receive signal;
generate detection information about the object by complex analysis to perform complexification on a correlation signal that represents a correlation between the transmit signal and the receive signal; and
define and function as a signal corrector configured or programmed to correct any of the correlation signal, the receive signal, and the transmit signal to mitigate a direct-current component in the correlation signal that is targeted for the complex analysis.

2. The object detection device according to claim 1, wherein the signal corrector is configured or programmed to, by performing a computational operation of removing a direct-current component in any of a cross spectrum including a frequency component of the correlation signal, a receive spectrum including a frequency component of the receive signal, and a transmit spectrum including a frequency component of the transmit signal, correct a corresponding signal among the correlation signal, the receive signal, and the transmit signal.

3. The object detection device according to claim 2, wherein
the controller is configured or programmed to convert the transmit signal into the transmit spectrum, convert the receive signal into the receive spectrum, and calculate the cross spectrum based on the transmit spectrum and the receive spectrum; and
the signal corrector is configured or programmed to correct the correlation signal by performing the computational operation on the cross spectrum.

4. The object detection device according to claim 2, wherein
the controller is configured or programmed to convert the transmit signal into the transmit spectrum and convert the receive signal into the receive spectrum; and
the signal corrector is configured or programmed to perform the computational operation on either the transmit spectrum or the receive spectrum and correct a corresponding signal that is the transmit signal or the receive signal.

5. The object detection device according to claim 1, wherein the signal corrector is configured or programmed to correct the receive signal generated by the wave receiver to cancel out a direct-current component in the receive signal and output the corrected receive signal to the controller.

6. The object detection device according to claim 1, wherein the controller is configured or programmed to, in complex analysis of the correlation signal, generate an analytic signal including an amplitude and a phase that are determined by a correlation between the transmit signal and the receive signal.

7. The object detection device according to claim 6, wherein the controller is configured or programmed to:
calculate an envelope of the analytic signal and detect a timing when the amplitude is largest based on the calculated envelope; and
generate the detection information based on the timing detected from the envelope.

8. The object detection device according to claim 1, wherein the detection information includes at least one of a displacement of the object in a predetermined measurement period and a distance to the object.

9. The object detection device according to claim 1, wherein the controller is configured or programmed to, using the correlation signal after a direct-current component of the correlation signal is mitigated by the signal corrector, calculate a quadrature component of the correlation signal and use the quadrature component for the complex analysis.

10. The object detection device according to claim 9, wherein
the correlation signal is determined by a cross-correlation function between the transmit signal and the receive signal; and
the controller is configured or programmed to perform the complex analysis by performing complexification on the cross-correlation function using the correlation signal and the quadrature component.

11. The object detection device according to claim 1, wherein the wave transmitter includes a thermophone to transmit a sound wave by generating heat in response to a transmit signal that includes a direct-current component.

12. An object detection method comprising:
outputting a transmit signal to a wave transmitter to cause the wave transmitter to transmit a sound wave toward an object;
obtaining a receive signal corresponding to the transmitted sound wave from a wave receiver to receive a sound wave and generate a receive signal that represents a reception result;
generating detection information about the object by complex analysis to perform complexification on a correlation signal that represents a correlation between the transmit signal and the receive signal; and
correcting any of the transmit signal, the receive signal, and the correlation signal to mitigate a direct-current component in the correlation signal that is targeted for the complex analysis.

13. The object detection method according to claim 12, further comprising performing a computational operation of removing a direct-current component in any of a cross spectrum including a frequency component of the correlation signal, a receive spectrum including a frequency component of the receive signal, and a transmit spectrum including a frequency component of the transmit signal, and correcting a corresponding signal among the correlation signal, the receive signal, and the transmit signal.

14. The object detection method according to claim 13, further comprising:
converting the transmit signal into the transmit spectrum, converting the receive signal into the receive spectrum, and calculating the cross spectrum based on the transmit spectrum and the receive spectrum; and
correcting the correlation signal by performing the computational operation on the cross spectrum.

15. The object detection method according to claim 13, further comprising:
converting the transmit signal into the transmit spectrum and converting the receive signal into the receive spectrum; and
performing the computational operation on either the transmit spectrum or the receive spectrum and correcting a corresponding signal that is the transmit signal or the receive signal.

16. The object detection method according to claim 12, further comprising correcting the receive signal generated by the wave receiver to cancel out a direct-current component in the receive signal and output the corrected receive signal.

17. The object detection method according to claim 12, further comprising, in complex analysis of the correlation signal, generating an analytic signal including an amplitude and a phase that are determined by a correlation between the transmit signal and the receive signal.

18. The object detection method according to claim 17, further comprising:
calculating an envelope of the analytic signal and detecting a timing when the amplitude is largest based on the calculated envelope; and
generating the detection information based on the timing detected from the envelope.

19. The object detection method according to claim 12, wherein the detection information includes at least one of a displacement of the object in a predetermined measurement period and a distance to the object.

20. A non-transitory computer-readable medium including a program to cause a controller to perform the object detection method according to claim 12.
